(19) United States
(12) Patent Application Publication
(10) Pub. No.: US 2024/0225042 A9
(43) Pub. Date: Jul. 11, 2024

(54) PLANT BASED MEAT ANALOG

(71) Applicant: ROQUETTE FRERES, Lestrem (FR)

(72) Inventor: Chandani PERERA, Batavia, IL (US)

(21) Appl. No.: 18/548,304

(22) PCT Filed: Feb. 24, 2022
(86) PCT No.: PCT/EP2022/025064

§ 371 Date: Aug. 29, 2023

Related U.S. Application Data
(63) Continuation of application No. 17/189,900, filed on Mar. 2, 2021.

(51) Int. Cl. A23J 3/22; A23J 3/14; A23L 33/185

(52) U.S. Cl. CPC A23J 3/227; A23J 3/14; A23L 33/185

(57) ABSTRACT

Provided is a plant-based meat analog comprising a hydrated textured protein, preferably a hydrated textured pea protein, and a pea protein isolate, its process and various industrial uses.

### BACKGROUND ART

Consumption of proteins from vegetable or plant in food products has been increasing over the years. Plant proteins are now widely used e.g. in dairy, baking, confectionary or even meat analog industries.

Meat analog (also termed as imitation meat, faux meat or mock meat) industry is a key application in this increasing use of plant proteins. Since many centuries, soy proteins was used in traditional food analogs such as tofu and tempeh which doesn't aims to mimic real animal meat. Meat analog industry really started in the 60's when texturized vegetable proteins (TVP) obtained from soy or gluten were developed and launched.

However, development of meat analogs that fits all specific consumers demand are still a huge topic and very challenging. Nutrition, texture and flavor are the main important parameters needed to be considered when developing a plant protein-based food.

Today, meat analog industry is focused on burger patties, chicken nuggets, and sausages. Other types of meat such as steak are not a main research and development subject due to the complexity in their structure composition (read “Meat the alternative-Australia's $3 billion opportunity”, King T and Lawrence S,. 2019).

In these particular categories, shawarma or gyros meat free analog are still a big challenge in terms of texture. Gyros is a Greek meal made from meat cooked on a vertical rotisserie. In Greece, gyros is normally made with pork, though other meats like lamb, beef or chicken are also used. Typical American mass-produced gyros are made with finely ground beef mixed with lamb. For hand-made gyros, meat is cut into approximately round, thin, flat slices, which are then stacked on a spit and seasoned. Fat trimmings are usually interspersed. Spices may include cumin, oregano, thyme, rosemary, and others. The pieces of meat, in the shape of an inverted cone, are placed on a tall vertical rotisserie, which turns slowly in front of a source of heat or broiler. As the cone cooks, lower parts are basted with the juices running off the upper parts. The outside of the meat is sliced vertically in thin, crisp shavings when done.

Some vegan homemade recipes including seitan (meat analog made from gluten) or based only on dairy or soy TVP (like taught in US20180368442 patent application) already exist but as it will be disclosed in the example part hereunder, result is still not at level of real gyros meat, especially in terms of texture and sliceability. With texturized protein, the challenge when producing gyros-like meat analog is to get a smooth texture, easily sliceable, which also provide good cohesiveness.

There is still a need to provide a meat free gyros recipe that answers this long term felt needs.

### GENERAL DESCRIPTION OF INVENTION

In a first aspect, the invention relates to a plant-based meat analog comprising a hydrated textured protein composition, preferably a hydrated textured pea protein composition, and a pea protein isolate.

In a preferred embodiment, the hydrated textured protein composition, preferably a hydrated textured pea protein composition, is characterized by a mean particle size which is comprised between 0.4 mm and 4 mm, more preferably comprised between 0.6 mm and 3.0 mm, even more preferably comprised between 0.7 mm and 2.0 mm.

In a more preferred embodiment the hydrated textured protein composition, preferably a hydrated textured pea protein composition, is hydrated with a protein/water weight ratio comprised between 1:2 and 1:4, more preferably between 1:2.2 and 1:2.6

In a more preferred embodiment, the weight percentage of hydrated textured protein composition, preferably hydrated textured pea protein composition, relative to the total weight of the plant-based meat analog, is comprised between 50% and 25%, more preferably between 45% and 30%, even more preferably between 37% and 34%, while the weight percentage of dry matter of protein isolate, preferably pea protein isolate, relative to the total weight of the plant-based meat analog, is respectively comprised between 10% and 0.5%, more preferably between 5% and 2%, even more preferably between 4% and 3%.

In another aspect, the invention also relates to a process of producing the plant-based meat analog of the invention comprising the following steps:
a) Hydration of a dry textured protein composition, preferably a dry textured pea protein composition, according to a weight protein/water ratio comprised between 1:2 and 1:4, more preferably between 1:2.2 and 1:2.6
b) Chopping of the hydrated textured protein composition obtained in step a), preferably a hydrated textured pea protein composition, and selection of the resulting particles in order to have a mean particle size comprised between 0.4 mm and 4 mm, more preferably comprised between 0.6 mm and 3.0 mm, even more preferably comprised between 0.7 mm and 2.0 mm
c) Addition to the chopped hydrated textured protein composition of at least one ingredient selected in the list of lipids, polysaccharides, flavor, lecithin, fibers, colorants and/or salts, and of a pea protein isolate in order to obtain a plant-based meat analog in which the weight percentage of hydrated textured protein composition, preferably hydrated textured pea protein composition, relative to the total weight of the plant-based meat analog is comprised between 50% and 25%, more preferably between 45% and 30%, even more preferably between 37% and 34%, while the weight percentage on dry matter of protein isolate, preferably pea protein isolate, relative to the total weight of the plant-based meat analog is respectively comprised between 10% and 0.5%, more preferably between 5% and 2%, even more preferably between 4% and 3%
d) Texturization of the plant-based meat analog obtained in step c) to obtain a final texturized plant-based meat analog.

In a last aspect, the invention also relates to the industrial uses of the plant-based meat analog of the invention, especially its use in food and feed industries.

Invention will be better understood in the following detailed description of the invention chapter.

### DETAILED DESCRIPTION OF THE INVENTION

The first aspect of this invention is a plant-based meat analog comprising a hydrated textured protein composition, preferably a hydrated textured pea protein composition, and a pea protein isolate.

In the present application, “plant based” must be understood as defining a composition, especially food and feed compositions, containing no products coming from animals. Preferably, “no products” must be understood as containing less than 5% on dry matter, more preferably less than 1% on dry matter, even more preferably less 0.1%. An even more restrictive definition would be 0%, even if some cross-contamination can occur e.g. in a plant process that produce vegan & dairy products.

In the present application, “meat analog” must be understood as a food or feed composition which aims to mimic real animal meat and especially meal derived from meat like burger patties, chicken nuggets or pork sausages. Common terms synonyms of “meat analogs” are plant-based meat, vegan meat, meat substitute, mock meat, meat alternative, imitation meat, or vegetarian meat, or, sometimes more pejoratively, fake meat or faux meat.

In the present application, “pea” must be considered in the broadest of its acceptable senses. In particular, it includes all varieties of “smooth pea” and of “wrinkled pea”, and all mutant varieties of “smooth pea” and of “wrinkled pea». These varieties relate to the uses that are usually intended for each pea type (food for human consumption, animal feed and/or other uses). In the present application, the term “pea” includes the varieties of pea belonging to the Pisum genus and more particularly to the sativum and aestivum species. Said mutant varieties are in particular those known as “r mutants”, “rb mutants”, “rug 3 mutants”, “rug 4 mutants”, “rug 5 mutants” and “lam mutants” as described in the article by C-L HEYDLEY et al. entitled “Developing novel pea starches”, Proceedings of the Symposium of the Industrial Biochemistry and Biotechnology Group of the Biochemical Society, 1996, pp. 77-87.

As it will be exemplified, addition of pea protein isolate will allow to procure a distinctive and superior organoleptic effect, especially in terms of texture (hardness). This superior effect is clearly an advantage when someone wants to produce a vegan gyros meat, but also every type of vegan meat analog, especially burger patties.

Even if pea source is the most preferred embodiment, some plants of the pea family (Leguminosae) can be also be encompassed under denomination of “pea”. These have seeds in pods, distinctive flowers, and typically root nodules. These nodules contain symbiotic bacteria that are able to fix nitrogen. In this pea family, fava bean or faba bean is especially preferred. Soy protein is clearly excluded.

In the present application, “textured” must be understood as generating fibers, especially protein-based fibers, in a food composition, especially meat analog. Any physical and/or chemical process aimed at modifying a composition containing proteins to give it a specific ordered structure will fit with this invention. In the context of the invention, texturization of proteins aims to give the appearance of a fiber, as in animal meat. Food extrusion is the preferred way to texture food composition containing proteins. It is a process by which a set of mixed ingredients are forced through an opening in a perforated plate or die with a design specific to the food and is then cut to a specified size by blades. By such extrusion process, protein isolate or concentrate can be transformed to Textured Vegetable Protein (TVP) which can be used in the meat analog or baking industries. In this application, dry extrusion is preferred. Dry extrusion is defined by an extrusion made with a water content below 30% of total raw material in the extruder feed.

In the present application, “protein” must be understood as molecules, having one or more long chains of amino-acid residues. In this application, proteins are understood in their native form or in a modified form, including hydrolyzed proteins. These proteins can be used from compositions of different concentrations, including isolates having a protein content of above 80% by dry weight on dry matter or concentrates having a protein content of between 50% and 80% by dry weight on dry matter. In this application, isolates in which the protein content is above 80% by dry weight on dry matter are particularly preferred.

In the present application, “isolate” must be understood as a protein composition which has a protein content of 80% or more by dry weight based on dry matter (protein content is estimated by assessing weight of total nitrogen multiplied by 6.25), preferably 85% or more by dry weight based on dry matter. Total nitrogen is preferably determined by using Kjeldahl assay method.

In a preferred embodiment, the textured pea protein composition is characterized by a mean particle size which is comprised between 0.4 mm and 4 mm, more preferably comprised between 0.6 mm and 3.0 mm, even more preferably comprised between 0.7 mm and 2.0 mm.

In the present application, “mean particle size” must be understood as the average size of particles present in a given sample. The mean particle size can be measured by using a Laser particle size analyzer which directly provides this parameter. The mean particle size should not be confused with others parameters such as median particle size, mode particle size, and particle size range.

A preferred method to measure particle size is using a wet Laser particle size analyzer attached with the liquid module (e.g. Malvern Mastersizer 3000) in which ground texturized protein particles are added into the liquid (water) module and 10 repeated cycles are run to get the mean particle size which is obtained automatically by the analyzer from the number particle size distribution.

As exemplified below, the use of a textured pea protein composition characterized by a mean particle size which is larger than 4 mm gave poor cohesiveness upon cooking of the obtained meat analog and a crumbly taste, whereas, use of textured pea protein composition smaller than 0.4 mm gave pasty mouthfeel.

A preferred way to produce a textured pea protein composition characterized by a mean particle size which is comprised between 0.4 mm and 4 mm, more preferably comprised between 0.6 mm and 3.0 mm, even more preferably comprised between 0.7 mm and 2.0 mm will be given in the following description, in the process embodiment part.

In a more preferred embodiment, a hydrated textured protein composition, preferably a hydrated textured pea protein composition, is prepared with a protein/water weight ratio comprised between 1:2 and 1:4, more preferably between 1:2.2 and 1:2.6

As exemplified below, a hydration ratio lower than 1:2 produced a dough which was too dry, whereas a hydration ratio higher than 1:4 gave too soft dough.

In a more preferred embodiment, in the plant-based meat analog, the weight percentage of hydrated textured protein composition, preferably hydrated textured pea protein composition, is comprised between 50% and 25%, more preferably between 45% and 30%, even more preferably between 37% and 34%, relative to the total weight of the plant-based meat analog, while the weight percentage on dry matter of protein isolate, preferably pea protein isolate, is respectively comprised between 10% and 0.5%, more preferably between 5% and 2%, even more preferably between 4% and 3% relative to the total weight of the plant-based meat analog.

In another aspect, the invention relates to a process of producing the plant-based meat analog of the invention comprising the following steps:
a) Hydration of a dry textured protein composition, preferably a dry textured pea protein, according to protein/water weight ratio comprised between 1:2 and 1:4, more preferably between 1:2.2 and 1:2.6
b) Chopping of the hydrated textured protein composition obtained in step a), preferably a hydrated textured pea protein composition, and selection of the resulting particles in order to have a mean particle size which is comprised between 0.4 mm and 4 mm, more preferably comprised between 0.6 mm and 3.0 mm, even more preferably comprised between 0.7 mm and 2.0 mm
c) Addition to the chopped hydrated textured protein composition of at least one ingredient selected in the list of lipids, polysaccharides, flavor, lecithin, fibers, colorants and/or salts, and of a pea protein isolate in order to obtain a plant-based meat analog in which the weight percentage of hydrated textured protein, preferably hydrated textured pea protein, relative to the total weight of the plant-based meat analog, is comprised between 50% and 25%, more preferably between 45% and 30%, even more preferably between 37% and 34%, while the weight percentage on dry matter of protein isolate, preferably pea protein isolate, relative to the total weight of the plant-based meat analog, is respectively comprised between 10% and 0.5%, more preferably between 5% and 2%, even more preferably between 4% and 3%
d) Texturization of the plant-based meat analog obtained in step c) to obtain a final texturized plant-based meat analog.

Step a) of the inventive process provides for hydration of dry textured pea protein composition.

As described above, a textured pea protein composition is a composition including at least pea protein that has been textured in order to mimic protein fibrils of meat. Pea protein can be selected from pea flour, pea concentrate or more preferently pea protein isolate. Texturization can be obtained by any means known by man skilled in the art but extrusion will be preferred. In a preferred embodiment, the textured pea protein composition is a composition containing pea protein and pea fiber wherein pea fiber percentage by weight on total weight of the composition is comprised between 10% and 20%, preferably between 12% and 18%, more preferably between 13% and 17%.

A dry textured pea protein composition is strongly preferred. A dry textured pea protein composition is defined as a textured pea protein composition which has a dry matter above 80%, preferably above 85%, preferably above 90%, more preferably above 95% by weight. It can be obtained by many means, but a preferred one will be by dry extrusion. Dry extrusion can be defined as extrusion of a pea protein composition as described above with addition of water at a weight percentage relative to the total weight feeding the extruder of less than 35%, preferably less than 30%, more preferably less than 25%, followed by drying. Other process can fit the invention including wet extrusion if it is combined with drying step.

In a preferred embodiment, a dry textured pea protein composition is characterized by a water retention capacity without chopping that is comprised between 1.0 and 6.0 grams of water per grams of protein, more preferably between 1.5 and 4, even more preferably between 2.0 and 2.5.

The protocol in order to measure water retention capacity without chopping (called test A) is described below:
Weigh 20 g of the product to be analyzed in a beaker
Add tap water which temperature is 20° C.+/−1° C. until complete submersion of sample
Allow hydration during 30 minutes without shaking
Remove residual water using a strainer (selected in order not to let samples particles in the liquid part) and isolate rehydrated sample
Weigh final rehydrated sample (called P)

Water retention without chopping (in g)=(P−20)/20.

It is preferred for the process that the textured pea protein composition possesses a water retention capacity without chopping that is comprised between 1.0 and 6.0 grams of water per grams of protein, more preferably between 1.5 and 4.0, even more preferably between 2.0 and 2.5. A textured pea protein composition having water retention capacity without chopping above 3 g will have a softer texture which is not desirable in plant-based gyros application. A water retention capacity below 1 g will lead to a too hard texture.

The dry textured protein composition is hydrated by mixing with water.

In a more preferred embodiment, the dry textured pea protein composition is hydrated with a protein/water weight ratio comprised between 1:2 and 1:4, more preferably between 1:2.2 and 1:2.6

As exemplified below, a hydration ratio lower than 1:2 produces a dough which is too dry, whereas a hydration ratio higher than 1:4 gives a too soft dough.

The preferred water source is selected in the list of tap water, demineralized water, decarbonated water, reverse osmosis treated water or filtered water.

The time for hydration is preferably comprised between 15 minutes and 1 hour, in order to reach absorption of the desired water ratio.

The preferred water temperature is comprised between 18 and 22° C. and the preferred pH is neutral, i.e. comprised between 6 and 8, preferably about 7. Hydration is done preferably in a static mode, but slow agitation can be used.

The water used for hydration may contain some level of additives like colorant, flavors.

Step b) provides for chopping the hydrated textured pea protein composition obtained in step a), in order to have a mean particle size which is comprised between 0.4 mm and 4 mm, more preferably comprised between 0.6 mm and 3.0 mm, even more preferably comprised between 0.7 mm and 2.0 mm

Chopping can be done by any means allowing to obtain particles having a mean particle size comprised between 0.6 mm and 3.0 mm, even more preferably comprised between 0.7 mm and 2.0 mm, by example using a food processor like e.g. Braun 12 cup Food Processor with Serrated blade. In this particular example and for a batch of 500 g hydrated textured pea protein, 5 min at speed 15 is required. FIG. 1 presents macroscopic pictures of hydrated & ground textured pea protein of various sizes.

In order to check if a hydrated textured pea protein composition has the required mean particle size, a mean particle size is preferred.

If the particles of hydrated textured protein are still too large, the chopping process will be adapted by extending time or speed.

After chopping and only if needed, particles can be selected by means of different sieves allowing to exclude particles above 3.0 mm and below 0.6 mm. As an alternative method, dry texturized protein particles can be ground to the desired size mentioned in this invention and then hydrated with water.

Step c) provides for the addition of at least one ingredient selected from the list of lipids, polysaccharides, flavor, lecithin, fibers, colorants and/or salts and of a pea protein isolate in order to obtain plant-based meat analog in which the weight percentage of hydrated textured protein, preferably hydrated textured pea protein, is comprised between 50% and 25%, more preferably between 45% and 30%, even more preferably between 37% and 34%, relative to the total weight of the plant-based meat analog, while percentage on dry matter of protein isolate, preferably pea protein isolate, is respectively comprised between 10% and 0.5%, more preferably between 5% and 2%, even more preferably between 4% and 3%, relative to the total weight of the plant-based meat analog.

Preferred examples of polysaccharides include cellulose derivatives, such as methylcellulose, maltodextrins, glucose syrup, native starch or modified starch.

Methylcellulose will be added to act in the formulation as a binder. It will aim to bind together all compounds and make them more cohesive.

Lipids are added in order to mimic juiciness of real meat. Preferred examples of lipids include vegetable oils, such as coconut and/or canola oil.

Fibers like pea fiber, gellan gum, acacia gum, xanthan gum, guar gum can also be added in order to modify texture and raise water binding.

Polysaccharides can also be added in order to improve texture.

Lecithin may be added to act as an emulsifier.

Flavor and colorants may be added in order to mimic color and flavor of meat.

Step d) provides for the texturization of the plant-based meat analog obtained from step c) to obtain a final texturized plant-based meat analog.

By “texturization”, the person skilled in the art will understand any process that initiates, establishes and/or reinforces structure and/or texture inside a composition.

Any processes known by the person skilled in the art will work, e.g. mixing, extrusion, packing or molding, molding being preferred.

In a preferred embodiment, texturization will be obtained by successive steps of mixing, molding, freezing and cooking. Molding aims to give shape to the composition, freezing is done by lowering temperature of the composition below 0° C., preferably at least during 24 h, and cooking, preferably by insertion into a gyros rotating cooker and heated until dough surface reached 74° C. Cooked dough is then sliced thinly (about 2-3 mm thick).

In a last aspect, the invention encompasses also industrial uses of the plant-based meat analog of the invention, especially its use in food and feed industries.

Main industrial uses will be the use in the food industry, particularly meat analog industry, especially for vegan gyros meat or vegan shawarma meat.

In a particular embodiment, the invention relates to a food or feed product comprising the plant-based meat analog of the invention.

Invention will be better understood in the following chapter.

### DESCRIPTION OF THE DRAWINGS

FIG. 1 shows macroscopic pictures of hydrated & ground textured pea protein of various sizes.

FIG. 2 shows the impact of particle size on plant-based gyros meat.

FIG. 3 shows the impact of textured pea protein/protein isolate weight ratio in plant-based meat analog on oil dripping while cooking.

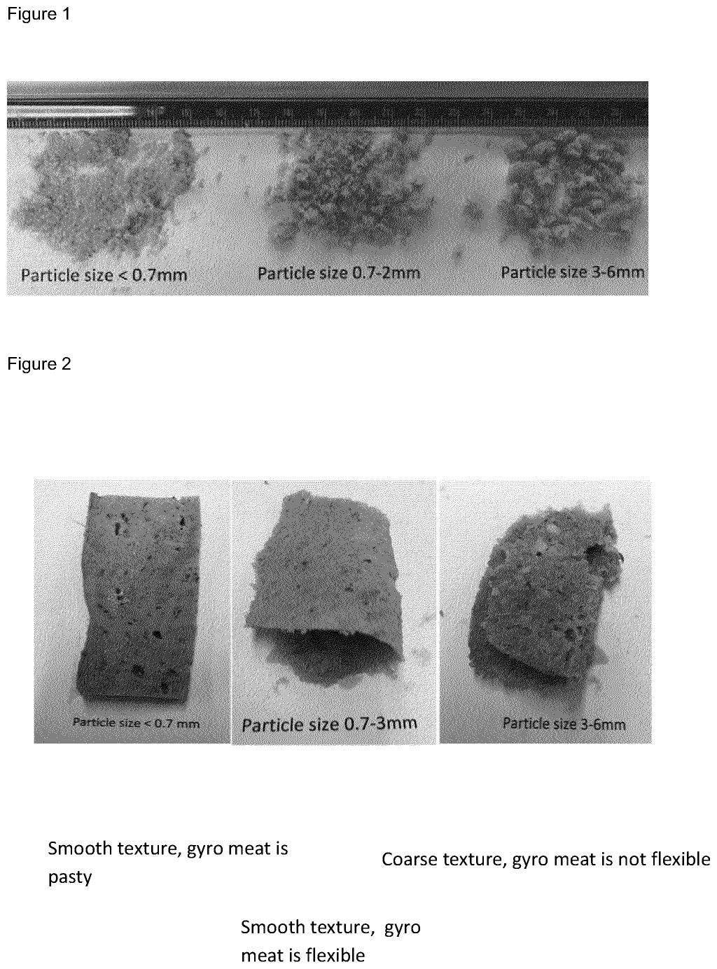

### EXAMPLES

### Example 1: Selection of Pea Protein Isolate Over Soy Isolate in a Meat Free Patty Burger

The aim of this example is to show with both simple (ground meat for burger style) and also more complex (gyros meat recipe) recipes, the influence of pea protein isolate over others plant isolates, especially soy isolate on the texture result.

For the burger recipe, the process involves three steps:
Emulsion formation (Table 1):

| | |
|---|---|
| METOLOSE MCE-100TS | 15 g |
| (Methyl-cellulose) | |
| Canola Oil | 225 g |
| (from Top Value) | |
| Ice | 210 g |
| Water | 300 g |

a. Disperse methylcellulose (Metolose MCE-100TS) into liquid vegetable oil.
b. Prepare ice+water in the mixer (ROBOT COUPE)
c. Add that methylcellulose & oil mix into ROBOT COUPE, during mixing.
d. Mix with ROBOTCOUPE mixer 3 times for 1 min, with help of a spatula between each mixing step in order to remove parts that are stick on sides of mixer bowl.
e. Store that emulsion in the refrigerator.
Rehydration of textured pea protein (NUTRALYS T70S® from Roquette) (Table 2)

| | |
|---|---|
| NUTRALYS ® T70S (textured pea | 312 |
| protein) | |
| Water | 844 |

a. Add the water and mix with NUTRALYS T70S, and store it at room temperature for 60 min.
b. After 60 minutes, put rehydrated NUTRALYS T70S into ROBOT COUPE, then chop it by 40 times repetition of a 1 second chopping step, in order to cut the NUTRALYS T70S.
Recipes of meat free patty (Table 3). (Quantities in grams)

| | Burger 1 | Burger 2 | Burger 3 | Burger 4 | Burger 5 | Burger 6 |
|---|---|---|---|---|---|---|
| NUTRALYS ® S85F (pea | 66.67 | | | | | |
| protein isolate) | | | | | | |
| Fine granulometry | | | | | | |
| NUTRALYS ® S85M (pea | | 66.67 | | | | |
| protein isolate) | | | | | | |
| Medium granulometry | | | | | | |
| NUTRALYS ® S85XF (pea | | | 66.67 | | | |
| protein isolate) | | | | | | |
| Extra-fine granulometry | | | | | | |
| NUTRALYS ® F85F (pea | | | | 66.67 | | |
| protein isolate) | | | | | | |
| Fine granulometry | | | | | | |
| NUTRALYS ® F85M (pea | | | | | 66.67 | |
| protein isolate) | | | | | | |
| Medium granulometry | | | | | | |
| SOLPY 6000H (soy isolate) | | | | | | 66.67 |

| | |
|---|---|
| Emulsion curd (Table 1) | 250 |
| Rehydrated NUTRALYS ® T70S | 192.67 |
| (Table 2) | |
| NaCl | 4.53 |
| Monosodium Glutamate « Umami | 2.5 |
| chomiryo » (from Ajinomoto) | |
| CLEARAM ® LG0020 (starch from | 1.27 |
| Roquette) | |

a. Add Emulsion, Rehydrated NUTRALYS T70S, NaCl, monosodium glutamate and CLEARAM LG0020, into Mixer, HOBART.
b. Mix them during 3 min.
c. Put the paste into moulds (80 g in each).
d. Cooking with steam at 98° C. for 10 min.

A comparison is also made with a commercial meat burger patty with an ingredient list comprising beef, pork, hamburger mix (bread crumb, onion, salt, sugar, hydrolysed protein, onion powder, pepper, milk powder, paprika, chicken extract, roasted garlic powder, nutmeg, roasted onion powder, allspice (ginger powder, egg powder, chili pepper, sautéed onion), trehalose, monosodium glutamate.

Patties burgers are tested with help of a texture analyzer (Shimadzu EZ-SX) according to the following procedure:
Warm up the patties by microwave oven at 500 W for 2 min.
Put hamburger steak patty on the TART texture analyzer stage, and push it with ball type chip with following conditions (Plunger:½ inc (1.27 cm) ball shape chip−Speed:1 mm/sec−Sample size:1 meal [80 g/hamburger steak mould])
Measures are done 6 times.

Two parameters are measured: the hardness (maximum value peak in Newtons) and hardness gap (variation between maximum peak value and value after leakage). Table 4 below summarizes values obtained:

| | Burger 1 | Burger 2 | Burger 3 | Burger 4 | Burger 5 | Burger 6 | Meat |
|---|---|---|---|---|---|---|---|
| Hardness (in Newtons) | 5.43 | 5.16 | 4.95 | 5.42 | 5.97 | 9.18 | 5.88 |
| Standard Deviation | 0.34 | 0.5 | 0.18 | 0.38 | 0.44 | 0.6 | 0.4 |
| Hardness gap (in Newtons) | 0.29 | 0.59 | 0.46 | 0.72 | 0.19 | 1.65 | 0.52 |
| Standard Deviation | 0.09 | 0.07 | 0.09 | 0.06 | 0.03 | 0.24 | 0.09 |

It can be clearly seen that hardness and hardness gap obtained with pea protein isolate based patties are much closer from meat than soy based.

Weights variation was also measured before and after heating. Table 5 below summarizes obtained values:

| | Burger 1 | Burger 2 | Burger 3 | Burger 4 | Burger 5 | Burger 6 | Meat |
|---|---|---|---|---|---|---|---|
| Mean weight | 94.1 | 93.6 | 93.3 | 93.8 | 93.7 | 96.6 | 88.4 |
| variation (in %) | | | | | | | |
| Standard Deviation | 1.3 | 0.9 | 1.3 | 0.8 | 0.7 | 1.5 | 1.8 |

Pea protein isolate based patties released significantly more juice when cooked in comparison with the soy-based patty, making it more close to a real meat burger patty.

### Example 2: Importance of Hydration Ratio of Textured Pea Protein

Alternative recipes are here made with textured pea protein with a mean particle size from 0.7 to 2 mm, according to the invention, but with higher and lower weight hydration ratios.

The procedure given below is for a 3 kg batch of dough for plant-based gyros. Textured pea protein was hydrated using the weight ratios of 1:1.8, 1:2.4, and 1:5. using 20° C. filtered water for 30 minutes. A batch of 1200 g methyl cellulose slurry was made by adding 50.4 g of methyl cellulose into 1149.6 g water at 4° C. in a container and mixing with a high shear mixer (Silverson) at 5000 rpm for 10 minutes. Into a Kitchen-aid mixing bowl, methyl cellulose slurry, flavors, salt, spices and caramel color were added and mixed at speed 2 for 7 minutes. Next, hydrated and ground texturized protein with a mean particle size from 0.7 to 2 mm (obtained according to the present invention and also with higher/lower weight hydration ratio) were obtained by chopping hydrated textured pea protein in a Braun 12 cup Food Processor equipped with Serrated blade, for 5 min at speed 15. The hydrated and ground texturized protein obtained is added in the Kitchen-aid mixing bowl and mixed at speed 2 for 5 minutes. Next, pea fiber, gellan gum, acacia gum, pregel pea starch, pregel potato starch, microcrystalline cellulose and pea protein isolate were added and mixed well. As the final step coconut oil was added and mixed at speed 2 for 4 minutes. The dough was molded in a gyros spit and froze for 24 hrs. When ready to cook the gyros in spit was inserted in the gyros cooker and cooked until dough surface reached 74° C. The cooked dough was sliced thinly (about 2-3 mm thick) and transferred on to a griddle on which the cooked dough was heated for another 1 minute before serving.

TABLE 6
below summarizes recipes:

| | Comparative | Invention | Comparative |
|---|---|---|---|
| Ingredients | example #1 | #1 | example #2 |
| (in weight | (Hydration | (Hydration | (Hydration |
| percentage) | (ratio 1:1.8) | ratio 1:2.4) | ratio 1:5) |
| Hydrated/ground | 36.67 | 36.67 | 36.67 |
| texturized pea | | | |
| protein (NUTRALYS T70S) | | | |
| 4.2% methyl | 39.00 | 39.00 | 39.00 |
| cellulose in Water | | | |
| Coconut oil 76° | 14.00 | 14.00 | 14.00 |
| Pea starch | 2.00 | 2.00 | 2.00 |
| Pea fiber I50M | 1.88 | 1.88 | 1.88 |
| Pea protein | 1.83 | 1.83 | 1.83 |
| isolate NUTRALYS F85F | | | |
| Plant based meat flavor | 1.24 | 1.24 | 1.24 |
| Pregel potato starch | 1.00 | 1.00 | 1.00 |
| Salt | 0.67 | 0.67 | 0.67 |
| Microcrystalline cellulose | 0.67 | 0.67 | 0.67 |
| Spices | 0.52 | 0.52 | 0.52 |
| Gellan gum | 0.34 | 0.34 | 0.34 |
| Acacia gum | 0.11 | 0.11 | 0.11 |
| Powdered Caramel color | 0.07 | 0.07 | 0.07 |
| Total | 100.00 | 100.00 | 100.00 |

As a control recipe, Gyros meat recipe made with meat is also produced with the following composition, in Table 7:

| Ingredients | Percent |
|---|---|
| Beef (85:15) 15% fat | 96.80 |
| Potato starch | 2.00 |
| Salt | 0.67 |
| Spices | 0.53 |
| Total | 100.00 |

A panel of 10 people was given to taste and compare the above recipes. A majority (8 on 10) found that gyros with hydration ratio of 1:1.8 was too dry and crumbly. The particles did not bind well to make a cohesive mass, whereas hydration ratio of 1:5 provided cohesive mass of gyros meat but was too soft compared to the gyros made with hydration ratio of 1:2.4 which is the closest to the meat reference.

### Example 3: Impact of Lower Mean Particle Size of Textured Pea Protein

The Example given below uses a mean particle size of less than 0.7 mm. In this formulation two pea protein isolates (NUTRALYS F85F and NUTRALYS F85G) were used in which the mean particle size of hydrated particles is 210 μm and 319 μm.

The procedure given below is for a 3 kg batch of dough for plant-based gyros. A batch of 1200 g methyl cellulose slurry was made by adding 50.4 g of methyl cellulose into 1149.6 g water at 4° C. in a container and mixing with a high shear mixer (Silverson) at 5000 rpm for 10 min. In a Kitchen-aid mixing bowl, water and protein isolate were mixed at speed 2 for 5 minutes. Then methyl cellulose slurry, flavors, salt, spices and caramel color were added and mixed at speed 2 for 7 minutes. Next pea fiber, gellan gum, acacia gum, pregel pea starch, pregel potato starch and microcrystalline cellulose were added and mixed well. As the final step, coconut oil was added and mixed at speed 2 for 4 minutes. The dough was molded in a gyros spit and frozen for 24 hrs. When ready to cook the gyros in spit was inserted in the gyros cooker and cooked until dough surface reached 74° C. The cooked dough was sliced thinly (about 2-3 mm thick) and transferred on to a griddle on which the cooked dough was heated for another 1 minute before serving.

TABLE 8

| | Comparative example #3 | Comparative example #4 |
|---|---|---|
| | Gyros formula with | Gyros formula with |
| | NUTRALYS F85F pea | NUTRALYS F85G pea |
| Ingredients | protein isolate hydrated | protein isolate Hydrated |
| (in weight | mean particle size | mean particle size |
| percentage) | 210 μm | 310 μm |
| 4.2% Methyl | 39.00 | 39.00 |
| cellulose in water | | |
| Water | 25.49 | 25.49 |
| Coconut oil 76° | 14.00 | 14.00 |
| Pea protein isolate | 13.00 | 13.00 |
| Pea starch | 2.00 | 2.00 |
| Pea fiber I50M | 1.88 | 1.88 |
| Vegan flavors | 1.24 | 1.24 |
| Pregel potato | 1.00 | 1.00 |
| starch | | |
| Salt | 0.67 | 0.67 |
| Microcrystalline | 0.67 | 0.67 |
| cellulose | | |
| Spices | 0.53 | 0.53 |
| Gellan gum | 0.34 | 0.34 |
| Acacia gum | 0.11 | 0.11 |
| Caramel color | 0.07 | 0.07 |
| powder | | |
| Total | 100.00 | 100.00 |

A panel of 10 people was given to taste and compare the above recipes given and compare it versus “Invention (Hydration ratio 1:2.4)” recipe (hydration ratio of 1:2.4 and mean particle size of 0.7-2 mm) from example 2

Panelist of sensory evaluation described gyros meat made with pea protein isolate with particles smaller than 0.7 mm as too pasty and not chewy as gyros meat made according to the invention.

### Example 4: Impact of Higher Mean Particle Size of Textured Pea Protein

The Example given below is for a mean particle size larger than 3 mm, in particular a mean particle size in the range of 3-6 mm. (To achieve the mean particle size of 3-6 mm, 500 g of hydrated (weight ratio 1:2.4) NUTRALYS T70S was chopped at speed 11 for 1.5 min in Braun food processor with serrated blade). The required amount of chopped textured protein for the procedure given below was made by repeating the chopping process several times. The procedure given below is for a 3 kg batch of dough for plant-based gyros. A batch of 1200 g methyl cellulose slurry was made by adding 50.4 g of methyl cellulose into 1149.6 g water at 4° C. in a container and mixing with a high shear mixer (Silverson) at 5000 rpm for 10 min. Into a Kitchen-aid mixing bowl, methyl cellulose slurry, flavors, salt, spices and caramel color were added and mixed at speed 2 for 7 minutes. Next, hydrated and ground texturized protein with a mean particle size from 3-6 mm was added and mixed at speed 2 for 5 minutes. Next pea fiber, gellan gum, acacia gum, pregel pea starch, pregel potato starch and microcrystalline cellulose were added and mixed well. As the final step coconut oil was added and mix at speed 2 for 4 minutes. The dough was molded in a gyros spit and froze for 24 hrs. When ready to cook the gyros in spit was inserted in the gyros cooker and cooked until dough surface reached 74° C. The cooked dough was sliced thinly (about 2-3 mm thick) and transferred on to a griddle on which the cooked dough was heated for another 1 minute before serving.

TABLE 9

| | Comparative example #5 |
|---|---|
| Ingredients | Hydrated/chopped texturized |
| (in weight | pea protein with mean particle |
| percentage) | size 3-6 mm |
| Hydrated/chopped | 36.67 |
| texturized pea protein | |
| mean particle size 3-6 mm | |
| (NUTRALYS T70S) | |
| (1:2.4 Texturized protein:water) | |
| 4.2% methyl cellulose in Water | 39.00 |
| Coconut oil 76° | 14.00 |
| Pea starch | 2.00 |
| Pea fiber I50M | 1.88 |
| NUTRALYS F85F | 1.83 |
| Vegan meat flavor | 1.24 |
| Pregel potato starch | 1.00 |
| Salt | 0.67 |
| Microcrystalline cellulose | 0.67 |
| Spices | 0.52 |
| Gellan gum | 0.34 |
| Acacia gum | 0.11 |
| Powdered Caramel color | 0.07 |
| Total | 100.00 |

In sensory evaluation done by 10 people, gyros meat made with large particles (3-6 mm) was described as too dry, crumbly and lack of cohesiveness.

FIG. 2 shows macroscopic pictures of gyros meat made respectively of Comparative example #4, Invention #1 and Comparative example #5. Anyone will clearly see that recipe Invention #1 possess a spongy texture that is not too pasty/cohesive (as Comparative example #4) or with big particles (as in Comparative example #5)

### Example 5: Importance of Use of Textured Pea Protein by Comparing with Soy Textured Protein

An alternative recipe was made with soy TVP (Arcon T) with the same process described for the invention which is given below.

The procedure given below is for a 3 kg batch of dough for plant-based gyros. A batch of 1200 g methyl cellulose slurry was made by adding 50.4 g of methyl cellulose into 1149.6 g water at 4° C. in a container and mixing with a high shear mixer (Silverson) at 5000 rpm for 10 min. Into a Kitchen-aid mixing bowl, methyl cellulose slurry, flavors, salt, spices and caramel color were added and mixed at speed 2 for 7 minutes. Next, hydrated (hydration weight ratio 1:2.4) and chopped textured soy protein to mean particle size of 0.7 to 2 mm (obtained following the present invention) was added and mixed at speed 2 for 5 minutes. Next, pea fiber, gellan gum, acacia gum, pregel pea starch, pregel potato starch, microcrystalline cellulose and pea protein isolate were added and mixed well. As the final step, coconut oil was added and mixed at speed 2 for 4 minutes. The dough was molded in a gyros spit and froze for 24 hrs. When ready to cook the gyros in spit was inserted in the gyros cooker and cooked until dough surface reached 74° C. The cooked dough was sliced thinly (about 2-3 mm thick) and transferred on to a griddle on which the cooked dough was heated for another 1 minute before serving.

Composition of the textured soy protein-based gyros is summarized below, in Table 10.

| Ingredients | Comparative example #6 |
|---|---|
| (in weight | Hydrated/chopped soy texturized |
| percentage) | protein |
| Hydrated/chopped soy | 36.67 |
| texturized protein (1:2.4) | |
| 4.2% methyl cellulose in Water | 39.00 |
| Coconut oil 76° | 14.00 |
| Pea starch | 2.00 |
| Pea fiber I50M | 1.88 |
| Pea Protein isolate | 1.83 |
| (NUTRALYS F85F) | |
| Vegan meat flavor | 1.24 |
| Pregel potato starch | 1.00 |
| Salt | 0.67 |
| Microcrystalline cellulose | 0.67 |
| Spices | 0.52 |
| Gellan gum | 0.34 |
| Acacia gum | 0.11 |
| Powdered Caramel color | 0.07 |
| Total | 100.00 |

Panelists of the sensory evaluation stated that soy-based gyros was found to be softer than the gyros with textured pea protein. This was also confirmed by the results of texture analysis of different plant-based gyros meats which are given in the table—at the end of this invention.

### Example 6: Comparison of Pea Protein Isolate, Soy Isolate and Wheat Gluten in Plant-Based Gyros

The aim of this example is to show the influence of protein isolates on the texture of plant-based gyros meat recipe.

Three recipes were made comparing pea, wheat and soy isolates. Compositions and preparation methods are summarized below: The procedure given below is for a 3 kg batch of dough for plant-based gyros. A batch of 1200 g methyl cellulose slurry was made by adding 50.4 g of methyl cellulose into 1149.6 g water at 4° C. in a container and mixing with a high shear mixer (Silverson) at 5000 rpm for 10 minutes. In a Kitchen-aid mixing bowl, water and protein isolate were mixed at speed 2 for 5 minutes. Then methyl cellulose slurry, flavors, salt, spices and caramel color were added and mixed at speed 2 for 7 minutes. Next, pea fiber, gellan gum, acacia gum, pregel pea starch, pregel potato starch and microcrystalline cellulose were added and mixed well. As the final step, coconut oil were added and mixed at speed 2 for 4 minutes. The dough was molded in a gyros spit and froze for 24 hrs. When ready to cook the gyros in spit was inserted in the gyros cooker and cooked until dough surface reached 74° C. The cooked dough was sliced thinly (about 2-3 mm thick) and transferred on to a griddle on which the cooked dough was heated for another 1 minute before serving.

TABLE 11

| | Comparative | Comparative | |
|---|---|---|---|
| | example #7 | example #8 | Comparative |
| Ingredients | Gyros-pea | Gyros-wheat | example #9 |
| (in weight | protein isolate | gluten isolate | Gyros-soy isolate |
| percentage) | based | based | based |
| 4.2% Methyl | 39.00 | 39.00 | 39.00 |
| cellulose in water | | | |
| Water | 25.49 | 25.49 | 25.49 |
| Coconut oil 76° | 14.00 | 14.00 | 14.00 |
| Protein powder | 13.00 | 13.00 | 13.00 |
| Pea starch | 2.00 | 2.00 | 2.00 |
| Pea fiber I50M | 1.88 | 1.88 | 1.88 |
| Vegan flavors | 1.24 | 1.24 | 1.24 |
| Pregel potato | 1.00 | 1.00 | 1.00 |
| starch | | | |
| Salt | 0.67 | 0.67 | 0.67 |
| Microcrystalline | 0.67 | 0.67 | 0.67 |
| cellulose | | | |
| Spices | 0.53 | 0.53 | 0.53 |
| Gellan gum | 0.34 | 0.34 | 0.34 |
| Acacia gum | 0.11 | 0.11 | 0.11 |
| Caramel color | 0.07 | 0.07 | 0.07 |
| powder | | | |
| Total | 100.00 | 100.00 | 100.00 |

A panel of 10 people tasted and compared the three recipes above versus the invention with textured pea protein.

A majority (8 out of 10) found that gyros meat made with gluten was soft and rubbery whereas gyros meat with soy isolate was softer than the gyros meat with pea protein isolate. All the gyros meats made only with protein isolates were softer than the gyros meat formulation according to the invention (with textured pea protein), as they did not deliver the meat-like chewy texture. This was further confirmed by the results obtained for texture analysis of gyros meats as shown in table 12 given below.

### Example 7: Importance of Textured Pea Protein/Pea Protein Isolate Ratio

Alternative recipes were made with textured pea protein with most preferred mean particle size of 0.7-2 mm, most preferred hydration ratio of 1:2.4 but with various pea protein isolate/textured pea protein ratio. The process was modified to release oil at a slower rate while cooking, so that the moistness of the gyros meat improved.

The modified procedure and compositions are given below.

The procedure given below is for 3 kg batch of dough for plant-based gyros. A batch of 1200 g methyl cellulose slurry was made by adding 50.4 g of methyl cellulose into 1149.6 g water at 4° C. in a container and mixing with a high shear mixer (Silverson) at 5000 rpm for 10 min. In a Waring blender one half of the methyl cellulose slurry that is needed in the recipe (585 g) was mixed with protein isolate at speed 5 for 4 minutes. Then, canola oil was added to make an emulsion while mixing at speed 5 for another 6-8 minutes. Into a Kitchen-aid mixing bowl, the second half of the methyl cellulose slurry (585 g), flavors, salt, spices, caramel color and the emulsion made with methyl cellulose were added and mixed at speed 2 for 7 minutes. Next, hydrated and chopped texturized protein with mean particle size from 0.7-2 mm (obtained following the present invention) was added and mixed at speed 2 for 5 minutes. Next pea fiber, gellan gum, acacia gum, pregel pea starch and pregel potato starch, pea protein isolate and microcrystalline cellulose were added and mixed well. As the final step, coconut oil 76° (melting range in 75-83F°) was added and mix at speed 2 for 4 minutes. The dough was molded in a gyros spit and froze for 24 hrs. When ready to cook the gyros in spit was inserted in the gyros cooker and cooked until dough surface reached 74° C. The cooked dough was sliced thinly (about 2-3 mm thick) and transferred on to a griddle on which the cooked dough was heated for another 1 minute before serving.

TABLE 12

| | | Invention #2 |
|---|---|---|
| Ingredients | | Improved |
| (in weight | | textured pea protein/ |
| percentage) | Invention #1 | isolate ratio |
| Hydrated/ground | 36.67 | 35.28 |
| texturized pea protein | | |
| (NUTRALYS T70S) (1:2.4 | | |
| Texturized protein:water) | | |
| 4.2% methyl cellulose in Water | 39.00 | 39.00 |
| Coconut oil 76° | 14.00 | 10 |
| Canola oil | 0.00 | 4.00 |
| Pea starch | 2.00 | 2.00 |
| Pea fiber I50M | 1.88 | 1.88 |
| Pea protein Isolate | 1.83 | 3.22 |
| (NUTRALYS F85F) | | |
| Plant based meat flavor | 1.24 | 1.24 |
| Pregel potato starch | 1.00 | 1.00 |
| Salt | 0.67 | 0.67 |
| Microcrystalline cellulose | 0.67 | 0.67 |
| Spices | 0.52 | 0.52 |
| Gellan gum | 0.34 | 0.34 |
| Acacia gum | 0.11 | 0.11 |
| Powdered Caramel color | 0.07 | 0.07 |
| Total | 100 | 100 |

Sensory evaluation showed that the improvement made by increasing the amount of pea protein isolate helped to increase the moistness of gyros meat by emulsifying some of the oil added in the formulation. Gyros meat of modified formula was juicier and more meat-like compared to the formula developed without emulsifying the oil (previous formula).

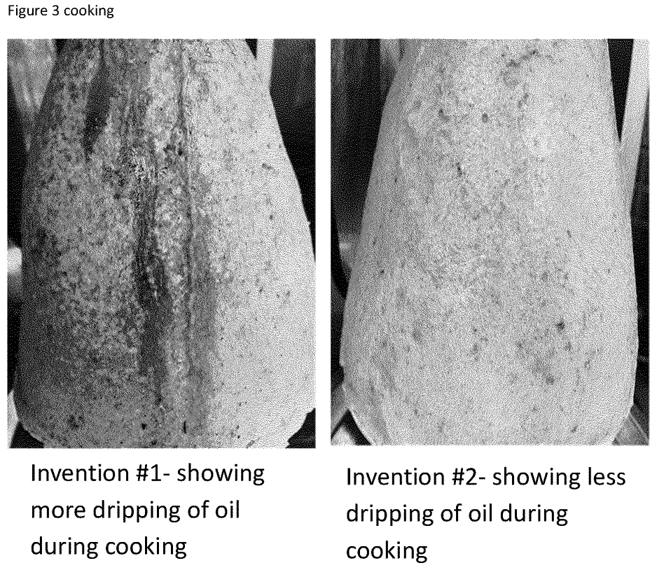

FIG. 3 shows macroscopic pictures of these two recipes while cooking. It is clearly shown that oil is less dripping in Invention #2

### Example 8: Texture (Firmness) Analysis of Gyros Meats

Texture (firmness) analysis of gyros meats was done by using TA-HD plus texture analyzer (Texture Technologies) attached with a 5 kg load cell. Texture of the cooked gyros was measured using Warner Bratzler blade with flat guillotine edge. The following conditions were applied: Mode-measure force in compression, Test speed of 2·mm/sec, distance traveled from the starting position of 25 mm. A piece of cooked gyros with 25 mm height, 40×40 mm width×length and at 35-38° C. was placed on the platform. The blade moves down from the start position to touch gyros slice and penetrates 5 mm. After that the blade proceed to the starting position and firmness (measured in grams) was measured.

TABLE 13
Firmness of gyros meats

| | | Comparative | Comparative | Comparative | | |
|---|---|---|---|---|---|---|
| | | example #6 | example #7 | example #8 | Comparative | Control |
| | Invention | (Soy TVP | Wheat | NUTRALYS | example #9 | gyros |
| Sample | #1 | fromARCONT) | Gluten | F85F | Soy Isolate | meat |
| Firmness | 1873.4 | 1537.7 | 897 | 1309 | 710 | 1858.9 |
| (g) | | | | | | |

As shown by above results, Invention #1 gyros is the closest to Meat control recipe in term of firmness. Soy textured or protein isolates gives a too smooth firmness.

1: A plant-based meat analog comprising a hydrated textured protein composition, and a pea protein isolate.

2: The plant-based meat analog of claim 1 wherein the hydrated textured protein composition is a hydrated textured pea protein composition.

3: The plant-based meat analog of claim 1 wherein the hydrated textured protein composition, has a mean particle size which is comprised between 0.4 mm and 4 mm.

4: The plant-based meat analog of claim 1 wherein the hydrated textured protein composition, has a mean particle size which is comprised between 0.6 mm and 3.0 mm.

5: The plant-based meat analog of claim 1 wherein the hydrated textured protein composition, has a mean particle size which is comprised between 0.7 mm and 2.0 mm.

6: The plant-based meat analog of claim 1 wherein the hydrated textured protein composition, is hydrated with a protein/water weight ratio comprised between 1:2 and 1:4.

7: The plant-based meat analog of claim 1 wherein the hydrated textured protein composition, is hydrated with a protein/water weight ratio comprised between 1:2.2 and 1:2.6.

8: The plant-based meat analog of claim 1 wherein the weight percentage of hydrated textured protein composition, is comprised between 50% and 25%, more preferably between 45% and 30%, even more preferably between 37% and 34%, relative to the total weight of the plant-based meat analog, and the weight percentage of dry matter of protein isolate, preferably pea protein isolate, is respectively comprised between 10% and 0.5%, more preferably between 5% and 2%, even more preferably between 4% and 3%, relative to the total weight of the plant-based meat analog.

9: A process of producing the plant-based meat analog of claim 1 comprising the following steps:
a) hydration of a dry textured protein composition, with protein/water weight ratio comprised between 1:2 and 1:4;
b) chopping of the hydrated textured protein composition obtained in step a), and selection of the resulting particles in order to have a mean particle size which is comprised between 0.4 mm and 4 mm;
c) addition to the chopped hydrated textured protein composition of at least one ingredient selected in the list of lipids, polysaccharides, flavor, lecithin, fibers, colorants and/or salts and of a pea protein isolate in order to obtain a plant-based meat analog in which the weight percentage of hydrated textured protein composition, is comprised between 50% and 25%, relative to the total weight of the plant-based meat analog, and the weight percentage on dry matter of protein isolate, is respectively comprised between 10% and 0.5%, relative to the total weight of the plant-based meat analog; and,
d) texturization of the plant-based meat analog obtained in step c) to obtain a final texturized plant-based meat analog.

10: A method of use of the plant-based meat analog of claim 1, comprising incorporating or shaping the plant-based meat analog in a food or feed product.

11: A food or feed product comprising the plant-based meat analog of claim 1.
